(19) United States
(12) Patent Application Publication
(10) Pub. No.: US 2024/0339631 A1
(43) Pub. Date: Oct. 10, 2024

(54) FUEL CELL STACK, FUEL CELL SYSTEM, AND PRODUCTION METHOD FOR PRODUCING A FUEL CELL STACK

(71) Applicant: Robert Bosch GmbH, Stuttgart (DE)

(72) Inventor: Eberhard Maier, Koengen (DE)

(21) Appl. No.: 18/291,426

(22) PCT Filed: Jul. 29, 2022
(86) PCT No.: PCT/EP2022/071415

§ 371 Date: Jan. 23, 2024

(30) Foreign Application Priority Data
Aug. 23, 2021 (DE) 10 2021 209 215.2

(51) Int. Cl. H01M 8/0202; H01M 8/1004

(52) U.S. Cl. CPC H01M 8/0202; H01M 8/1004

(57) ABSTRACT

The presented invention relates to a fuel cell stack (100) for providing electrical energy. The fuel cell stack (100) comprises a number of bipolar plates (BPP) (101) and a number of membrane electrode assemblies (MEA) (103). Respective MEA (103) of the number of MEA (103) and respective BPP (101) of the number of BPP (101) are stacked on each other in alteration. The MEA (103) and the BPP (101) each have an opening (105, 300, 400, 500), and the openings (105, 300, 400, 500) of all the MEA (103) and the BPP (101) jointly form an alignment receptacle (109) for receiving an alignment tool (107).

The membrane electrode assemblies (MEA) (103) protrude, at least in parts, further into the alignment receptacle (109) than each bipolar plate (BPP) (101), so that adjacent BPP (101) surrounding one of the MEA (103) are electrically insulated from each other by said MEA (103).

### BACKGROUND

The structure of a fuel cell stack of a fuel cell system comprises a plurality of fuel cells stacked on top of each other. As a rule, fuel cells in a fuel cell stack are formed by bipolar plates (BPP) and a membrane electrode assembly (MEA). The BPP is in this case usually made of a metal or graphite. Accordingly, BPP are rigid components.

The MEA as the actual chemically active unit is a flexible or non-rigid component. An electrochemically active surface of the MEA is enclosed by a carrier frame made of, e.g., polyethylene naphthalate (PEN). Due to the flexibility and bendability of the MEA, it is difficult to align or move it relative to the BPP. In addition to the flexible properties, the PEN support frame exhibits large tolerances depending on operation and production, which is detrimental to an exact relative alignment of BPP to membrane electrode assemblies.

### SUMMARY

Presented in the context of the invention are a fuel cell stack, a fuel cell system, and a production method for producing the fuel cell stack or fuel cell system. Further features and details of the invention will emerge from the description and the drawings. In this context, features, and details described in connection with the fuel cell stack according to the invention clearly also apply in connection with the fuel cell system according to the invention and the production method according to the invention, and vice versa so, with regard to the disclosure, reference is or can always be made to the individual aspects of the invention reciprocally.

The invention presented is used to provide a robust fuel cell system. In particular, the invention presented is used to prevent short circuits between different BPP of a fuel cell system when they are aligned relative to a MEA.

Therefore, presented according to a first aspect of the invention presented is a fuel cell stack for providing electrical energy. The fuel cell stack comprises a number of bipolar plates (BPP) and a number of membrane electrode assemblies (MEA), whereby the respective MEA of the number of MEA and the respective BPP of the number of BPP are stacked in alteration on top of each other. The MEA and BPP each comprise an opening and the respective openings of all MEA and BPP together form an alignment receptacle for receiving an alignment tool. A respective MEA protrudes, in particular by means of a seal, at least in parts further into the alignment receptacle than the respective BPP, so that the MEA electrically insulates the respective adjacent BPP, which surround the MEA, from each other.

In the context of the invention presented, the term “alignment receptacle” is understood to mean an opening or a plurality of openings in the BPP and MEA of a fuel cell stack, into which an alignment tool can be inserted in order to align the BPP and MEA relative to one another. An alignment receptacle generally has a negative shape relative to a positive shape of an alignment tool, whereby, according to the invention, the negative shape of the alignment receptacle is, at least in parts, narrowed in cross-section relative to the positive shape by means of the MEA so that at least parts of the positive shape and negative shape, or rather the alignment tool and MEA, overlap.

By overlapping the positive shape of the alignment tool and the negative shape of the respective MEA, a distance or gap between the MEA and the alignment tool, in which two BPP may touch and cause a short circuit, is avoided.

Furthermore, by overlapping the positive shape of the alignment tool and the negative shape of the respective MEA, a variance in the length of different MEA is compensated for and contact between the alignment tool and MEA is ensured so that a short circuit caused by BPP touching each other due to MEA of different lengths is avoided.

The combination of an alignment receptacle for receiving an alignment tool and a MEA protruding further into the alignment receptacle relative to a BPP ensures precise positioning of the MEA relative to the BPP by means of the alignment tool and prevents a short circuit between the BPP. Accordingly, this combination results in some of the advantages described hereinafter.

Insufficient alignment of a chemically active area of a MEA with respect to an area provided on a BPP can lead to an undersupply of gases to the chemically active area by the BPP and consequently to a degradation of the active area. Accordingly, an optimal alignment of MEA to BPP in the fuel cell stack according to the invention maximizes an effective chemically active area and thus maximizes a performance of the fuel cell stack.

Furthermore, the fuel cell stack according to the invention enables a particularly small protrusion of a seal of a respective MEA relative to a respective BPP at the edge and in respective supply channels due to an exact positioning of the MEA relative to the BPP. Particularly in the supply channels, this leads to an advantageous flow behavior in that a flow cross-section in the supply channels is not or only minimally constricted.

It can be provided that a cross-section of the opening of a respective MEA is, at least in parts, smaller than or equal to a cross-section of the alignment tool.

A cross-section of the opening of a respective MEA, parts of which are smaller than a cross-section of the alignment tool, results in contact between the MEA and the alignment tool only in some parts, so that frictional energy is minimized when moving the alignment tool along the MEA and jamming of the alignment tool on the MEA or the respective MEA is prevented.

It can also be provided that a respective MEA has a number of recesses at the edge of its opening, which enable flexible movement of the MEA in the area of the opening.

Recesses, e.g. slots in the area of the edge of an opening for receiving an alignment tool of a MEA, make the area particularly flexible so that it can move with the alignment tool when the alignment tool moves along the MEA and prevents or covers a gap between the alignment tool and the MEA.

It can also be provided that the opening is circular and that the number of recesses of the opening is arranged around the opening at an even distance from each other.

Round or cylindrical alignment tools have proven to be particularly advantageous for insertion into an alignment receptacle. In order to flexibly design a round negative shape corresponding to the round positive shape of such an alignment tool, evenly spaced recesses, such as slots, have proven to be advantageous, as these prevent uneven movement of the MEA when the alignment tool moves along the MEA.

It is also possible for the opening to have an elongated shape with two parallel straight lines and for the number of recesses to be evenly spaced along the straight lines.

An elongated opening can be arranged diagonally in a MEA, for example, so that a corresponding alignment tool aligns the MEA over a wide range in both the longitudinal and transverse directions when moving through the opening.

A second aspect of the presented invention relates to a production method for producing a fuel cell stack. The production method comprises a stacking step, during which a plurality of bipolar plates (BPP) and a plurality of membrane electrode assemblies (MEA) are stacked in alteration, whereby the MEA and BPP each comprise an opening and the respective openings of all MEA and BPP together form an alignment receptacle for receiving an alignment tool, and whereby a respective MEA extends further into the alignment receptacle than a respective BPP so that the MEA electrically insulates respective adjacent BPP surrounding the MEA from each other. The production method further comprises an alignment step, during which an alignment tool is inserted into the alignment receptacle to align the number of MEA and the number of BPP relative to each other, a fixing step, during which the number of MEA and the number of BPP are fixed in their aligned position, and a removal step, during which the alignment tool is removed from the fuel cell stack.

The production method presented is in particular used to produce the fuel cell stack presented.

It can be provided that, when the alignment tool is inserted into the alignment receptacle, jamming of the alignment tool in the alignment receptacle is prevented by using the MEA whose cross-section of the opening is, merely in parts, smaller than or equal to a cross-section of the alignment tool.

The use of a MEA with an opening cross-section, parts of which are smaller than the cross-section of an alignment tool, means that the MEA and alignment tool are only in contact in some areas, so frictional energy is minimized when the alignment tool moves along the MEA and jamming of the alignment tool on the MEA or the respective MEA is prevented.

It can also be provided that, when the alignment tool is inserted into the alignment receptacle, jamming of the alignment tool in the alignment receptacle is prevented by using MEA provided with a number of recesses at the edge of the opening in order to enable flexible movement of the seal in the area of the opening.

The use of a MEA with an opening, at the edge of which recesses are provided, results in a particularly flexible behavior of the MEA in the area of the opening, so that frictional energy is minimized when moving the alignment tool along the MEA and jamming of the alignment tool on the MEA or the respective MEA is prevented.

It can also be provided that, when the alignment tool is inserted into the alignment receptacle, the MEA are moved from a home position to a deflected position and when the alignment tool is removed from the fuel cell stack, the MEA are moved back from the deflected position to the home position.

In order to prevent a short circuit between different BPP, a MEA that can be flexibly moved between a home position and a deflected position or reversibly moved into a deflected position has proven to be particularly suitable, as a gap between the alignment tool and the MEA is prevented when moving from the home position to the deflected position and a protrusion of the MEA relative to the BPP is ensured when moving back to the home position. Accordingly, the movement of the MEA continuously covers an area between respective BPP when an alignment tool is moved through the fuel cell stack presented, so the BPP are continuously electrically insulated from each other and a short circuit between the BPP is prevented.

In a third aspect, the presented invention relates to a fuel cell system with one possible embodiment of the presented fuel cell stack.

Further advantages, features, and details of the invention will emerge from the following description, in which exemplary embodiments of the invention are described in detail with reference to the drawings. The features specified in the claims and in the description can each be essential to the invention individually or in any combination.

### BRIEF DESCRIPTION OF THE DRAWINGS

### Shown are:

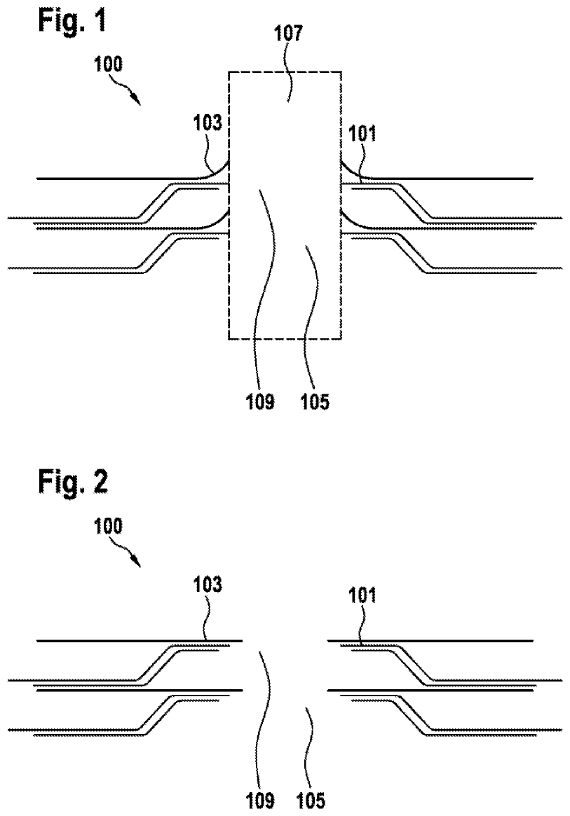

FIG. 1 a detailed view of a possible embodiment of the fuel cell stack with alignment tool presented,

FIG. 2 a detailed view of the fuel cell stack according to FIG. 1 without the alignment tool,

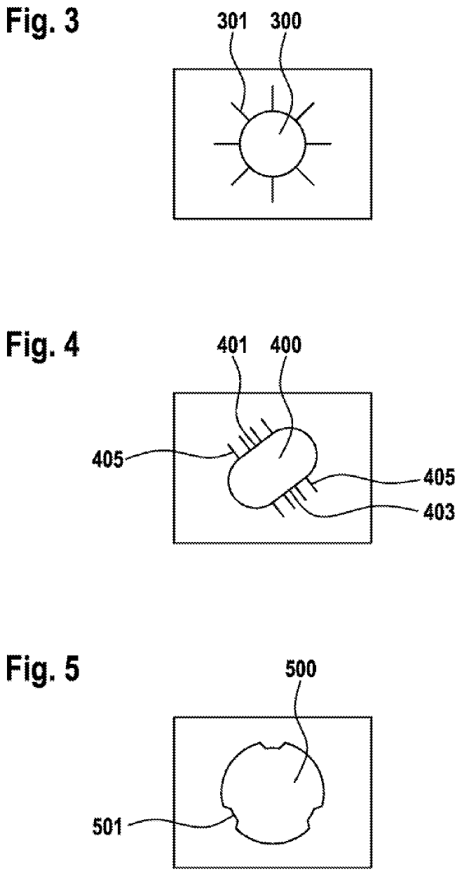

FIG. 3 a first possible embodiment of an opening for receiving an alignment tool of a MEA of a possible embodiment of the fuel cell stack presented,

FIG. 4 a second possible embodiment of an opening for receiving an alignment tool of a MEA of a possible embodiment of the fuel cell stack presented,

FIG. 5 a third possible embodiment of an opening for receiving an alignment tool of an MEA of a possible embodiment of the fuel cell stack presented,

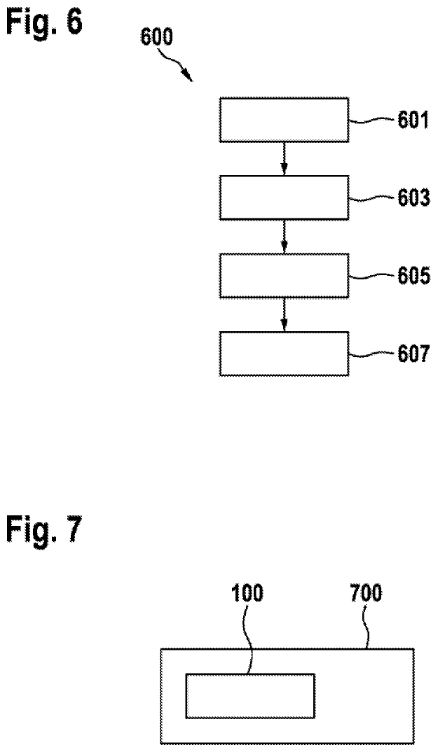

FIG. 6 a possible embodiment of the production method presented,

FIG. 7 a possible embodiment of the fuel cell system presented.

### DETAILED DESCRIPTION

FIG. 1 shows a fuel cell system 100. The fuel cell stack 100 comprises a number of bipolar plates (BPP) 101 and a number of membrane electrode assemblies (MEA) 103, which are stacked on top of each other.

The BPP 101 and the MEA 103 each comprise an opening 105 for inserting an alignment tool 107.

Given that the MEA 103 protrude further into the openings 105 or an alignment receptacle 109 formed by the openings 105 than the BPP 101 (as can be clearly seen in particular in FIG. 2) the MEA 103 overlap a movement range of the alignment tool 107, so that the alignment tool 107 contacts the MEA 103 in the region of the openings 105 and moves it from a basic position into a deflected position, as shown in FIG. 1. Accordingly, the MEA 103 continuously contacts the alignment tool 107 while the alignment tool 107 moves through the openings 105 or through the alignment receptacle 109.

During the movement of the alignment tool 107 through the openings 105 or the alignment receptacle 109 formed by the openings 105, the alignment tool 107 urges the BPP 101 and the MEA 103 into a predetermined position relative to the alignment tool 107 and relative to one another, so that a chemically reactive surface of the respective MEA 103 overlaps on flow areas provided exactly corresponding to the respective BPP 101 and is optimally supplied with fuels.

Given that the MEA 103 protrude further into the openings 105 or the alignment receptacle 109 than the BPP 101, a gap between the respective BPP 101 is continuously covered by the MEA 103, in particular during a movement process of the BPP 101 and the MEA 103 induced by the alignment tool 107. Accordingly, the respective BPP 101 are electrically insulated from each other by the respective MEA 103 even when the BPP 101 and the MEA 103 move relative to each other.

In particular, the MEA 103 protruding further into the openings 105 or the alignment receptacle 109 relative to the BPP 101 equalizes or compensates for manufacturing tolerances in a length of the BPP 101 and the MEA 103. In particular, a length of a distance by which the MEA 103 protrudes further into the openings 105 or the alignment receptacle 109 than the BPP 101 is greater than a manufacturing tolerance of the MEA 103.

FIG. 2 shows the fuel cell stack 100 without the alignment tool 107. Accordingly, it is clearly recognizable here that the MEA 103 protrude further into the openings 105 or the alignment receptacle 109 than the BPP 101.

FIG. 3 shows a first possible embodiment of an opening 300 for receiving an alignment tool. The opening 300 is inserted into a MEA of a fuel cell stack (not shown in this case). In particular, the opening is inserted into a seal of the MEA.

The opening 300 is circular and is used to receive a round or cylindrical alignment tool.

The opening 300 is surrounded by evenly spaced recesses 301, which enable a high degree of flexibility or deformability of the MEA in the area of an edge of the opening 300, so that the edge continuously adjoins the alignment tool while the alignment tool moves through the opening 300.

The high degree of flexibility of the MEA due to the recesses 301 in the area of the edge of the opening 300 minimizes the mechanical resistance that the alignment tool has to overcome when moving through the opening 300 and prevents the alignment tool from jamming in the opening 300.

FIG. 4 shows a second possible embodiment of an opening 400 for receiving an alignment tool. The opening 400 is inserted into a MEA of a fuel cell stack (not shown in this case). In particular, the opening is inserted into a seal of the MEA.

The opening 400 is elongated with two parallel straight lines 401 and 403 and accordingly is used to receive an elongated alignment tool.

The opening 400 is arranged diagonally in the MEA so that the alignment tool moves the MEA in the longitudinal and transverse directions when the alignment tool moves through the opening.

The opening 400 is surrounded at the straight lines 401 and 403 by recesses 405, which enable a high flexibility or deformability of the MEA in the area of an edge of the opening 400, so that the edge continuously adjoins the alignment tool while the alignment tool moves through the opening 400.

The high degree of flexibility of the MEA due to the recesses 405 in the area of the edge of the opening 400 minimizes the mechanical resistance that the alignment tool has to overcome when moving through the opening 400 and prevents the alignment tool from jamming in the opening 300.

FIG. 5 shows a third possible embodiment of an opening 500 for receiving an alignment tool. The opening 500 is inserted into a MEA of a fuel cell stack (not shown in this case). In particular, the opening is inserted into a seal of the MEA.

The opening 500 is narrowed by three protuberances or protrusions 501, which extend from a substantially round shape of an edge of the opening 500 towards a center of the opening 500. Accordingly, the opening 500 receives a round or cylindrical alignment tool.

The protrusions 501 cause the MEA to continuously contact the alignment tool as the alignment tool moves through the opening 500, whereby a mechanical resistance or frictional energy that the alignment tool must overcome when moving through the recess 500 is reduced due to the protrusions 501 as compared to a continuously contacting surface.

FIG. 6 shows a production method 600 for producing a fuel cell stack.

The production method 600 comprises a stacking step 601, during which a plurality of bipolar plates (BPP) and a plurality of membrane electrode assemblies (MEA) are stacked on each other in alteration, whereby the MEA and BPP each comprise an opening, and the respective openings of all the MEA and the BPP jointly form an alignment receptacle for receiving an alignment tool, in which case a respective MEA extends further into the alignment receptacle than a respective BPP so that the MEA electrically insulates respective adjacent BPP surrounding the MEA from each other.

The production method 600 further comprises an alignment step 603, during which an alignment tool is inserted into the alignment receptacle to align the plurality of MEA and the plurality of BPP relative to each other, a fixing step 605, during which the plurality of MEA and the plurality of BPP are fixed in their aligned position, and a removal step 607, during which the alignment tool is removed from the fuel cell stack.

FIG. 7 shows a fuel cell system 700. The fuel cell system 700 comprises a fuel cell stack, e.g. the fuel cell stack 100 shown in FIG. 1.

1. A fuel cell stack (100) for providing electrical energy, the fuel cell stack (100) comprising:
a number of bipolar plates (BPP) (101) and
a number of membrane electrode assemblies (MEA) (103),
wherein respective MEA (103) of the number of MEA (103) and respective BPP (101) of the number of BPP (101) are stacked on each other in alteration,
wherein the MEA (103) and the BPP (101) each have an opening (105, 300, 400, 500), and the respective openings (105, 300, 400, 500) of all the MEA (103) and the BPP (101) jointly form an alignment receptacle (109) for receiving an alignment tool (107), and
wherein the MEA (103) protrude, at least in parts, further into the alignment receptacle (109) than each BPP (101), so that adjacent BPP (101) surrounding one of the MEA (103) are electrically insulated from each other by said MEA (103).

2. The fuel cell stack (100) according to claim 1,
wherein
a cross-section of the opening (105, 300, 400, 500) of a respective MEA (103) is, at least in parts, smaller than or equal to a cross-section of the alignment tool (107).

3. The fuel cell stack (100) according to claim 1,
wherein
a respective MEA (103) has a number of recesses (405, 301) at an edge of its opening (105, 300, 400, 500), which enable flexible movement of the MEA (103) in a region of the opening (105, 300, 400, 500).

4. The fuel cell stack (100) according to claim 3,
wherein
the opening (105, 300) is circular, and the number of recesses (301) of the opening (105, 300) are arranged around the opening (100, 300) at a uniform distance from one another.

5. The fuel cell stack (100) according to claim 3,
wherein
the opening (400) has an elongate shape with two parallel straight lines (401, 403), and the number of recesses (405) are arranged at uniform distances on the straight lines (401, 403).

6. A production method (600) for producing a fuel cell stack (100),
the production method (600) comprising:
a stacking step (601), during which a number of BPP (101) and a number of membrane electrode assemblies (MEA) (103) are stacked on each other in alteration,
wherein the MEA (103) and BPP (101) each comprise an opening (105, 300, 400, 500), and the respective openings (105, 300, 400, 500) of all the MEA (103) and the BPP (101) jointly form an alignment receptacle (109) for receiving an alignment tool (107), and wherein respective MEA (103) protrude further into the alignment receptacle (109) than respective BPP (101), so that a respective MEA (103) electrically insulates adjacent BPP (101), which surround the MEA (103), from one another,
an alignment step (603), during which the alignment tool (107) is inserted into the alignment receptacle (109) to align the plurality of MEA (103) and the plurality of BPP (101) relative to each other,
a fixing step (605), during which the number of MEA (103) and the number of BPP (101) are fixed in their aligned position,
a removal step (607), during which the alignment tool (107) is removed from the fuel cell stack (100).

7. The production method (600) according to claim 6,
wherein,
when the alignment tool (107) is inserted into the alignment receptacle (109), jamming of the alignment tool (107) in the alignment receptacle (109) is prevented by using MEA (103) whose cross-section of the opening (105) is, merely in parts, smaller than or equal to a cross-section of the alignment tool (107).

8. The production method (600) according to claim 6,
wherein,
when the alignment tool (107) is inserted into the alignment receptacle (109), jamming of the alignment tool (107) in the alignment receptacle (109) is prevented by using MEA (103) provided with a number of recesses (301, 405) at an edge of the opening (105, 300, 400, 500) in order to enable flexible movement of the MEA (103) in a region of the opening (105, 300, 400, 500).

9. The production method (600) according to claim 6,
wherein,
when the alignment tool (107) is inserted into the alignment receptacle (109), the MEA (103) is moved from a home position to a deflected position and, when the alignment tool (107) is removed from the fuel cell stack (100), the MEA (103) is moved back from the deflected position to the home position.

10. A fuel cell system (700) comprising a fuel cell stack (100) according to claim 1.
